(19) United States
(12) Patent Application Publication
(10) Pub. No.: US 2016/0321313 A1
(43) Pub. Date: Nov. 3, 2016

(54) SYSTEMS AND METHODS FOR DETERMINING WHETHER A DESCRIPTIVE ASSET NEEDS TO BE UPDATED

(71) Applicant: ROVI GUIDES, INC., Santa Clara, CA (US)

(72) Inventor: Brian C. Peterson, Barrington, IL (US)

(21) Appl. No.: 14/701,354

(22) Filed: Apr. 30, 2015

(51) Int. Cl. G06F 17/30; G06Q 30/02

(52) U.S. Cl. CPC G06F 17/30365; G06F 17/30368; G06F 17/30371; G06F 17/30867; G06Q 30/0264

(57) ABSTRACT

Systems and methods are described herein for determining whether a descriptive asset needs to be updated. According to one aspect, control circuitry may determine that a descriptive asset corresponding to a media asset may require revision, wherein the descriptive asset was last updated at a point in time. The control circuitry may retrieve the descriptive asset from a database and analyze each term of a plurality of terms of the descriptive asset to identify terms that, at the point in time, were unimportant. In response to identifying a term of the plurality of terms that, at the point in time, was unimportant, the control circuitry may determine whether, at a present time, the term is now important. In response to determining that, at the present time, the term in the descriptive asset is now important, the control circuitry may generate a notification to update the descriptive asset.

### BACKGROUND

Media providers typically provide users with a wide variety of information about media assets, such as a title of the media asset, actor/actress information, director/producer information, genre, times when the media asset is available, and sources on which the media asset may be accessed. The media asset may also be associated with descriptive assets, such as synopses, plot summaries, editorial reviews, user reviews, video previews, trailers, articles, and other descriptions. Such descriptive assets may be text only, such as a newspaper article, audio/video, such as a movie trailer, or a combination of both.

Over time, a descriptive asset may become outdated as various aspects of the media asset become more or less popular. For example, a descriptive asset, such as a music album review, may have been written when a band was relatively new and unknown, but over time, the band may have become very popular.

### SUMMARY

Systems and methods are described herein for determining whether a descriptive asset needs to be updated. According to one aspect, control circuitry may determine that a descriptive asset corresponding to a media asset may require revision. The descriptive asset may be a review, synopsis/summary, trailer, preview, article, or any other description of the media asset. The descriptive asset may have been created or last updated at a point in time in the past. In some embodiments, the control circuitry may determine that the descriptive asset may require revision by determining that a period of time has elapsed since the point in time that the descriptive asset was last updated. In this manner, the control circuitry may periodically check whether the descriptive asset has become outdated.

In some embodiments, the control circuitry may retrieve the descriptive asset from a database and analyze each term of a plurality of terms of the descriptive asset to identify terms that, at the point in time, were unimportant. In response to identifying a term of the plurality of terms that, at the point in time, was unimportant, the control circuitry may determine whether, at a present time, the term is now important. As an illustrative example, the descriptive asset may be a plot summary of a movie and identify a number of lead actors and a number of secondary actors. The control circuitry may determine that a secondary actor was unimportant at the point in time that the descriptive asset was last updated. For instance, the secondary actor may have been an actor who was relatively unknown at the time that the descriptive asset was created or last updated. The control circuitry may then determine that the secondary actor is now important. For instance, the control circuitry may access an Internet database with actor information and determine, based on information in the Internet database, that the secondary actor has played the lead role in several recent blockbuster movies. In response to determining that, at the present time, the term in the descriptive asset is now important, the control circuitry may generate a notification to update the descriptive asset. For example, the control circuitry may generate an alert to a human editor of the descriptive asset that the descriptive asset needs to be updated.

In some embodiments, the control circuitry may identify terms that were unimportant at the point in time by referring back to promotional material. The control circuitry may retrieve promotional material corresponding to the media asset, wherein the promotional material is dated prior to the point in time. The control circuitry may also retrieve an editor-generated set of data corresponding to the media asset, wherein the editor-generated set of data is dated prior to the point in time and identify a subset of terms of the editor-generated set comprising terms that are not in the promotional data. In order to determine whether terms of the descriptive asset are unimportant, the control circuitry may compare each term of the plurality of terms of the descriptive asset to the subset of terms and determine that each term of the plurality of terms that matches a term of the subset was not important at the point in time.

As an illustrative example, the control circuitry may retrieve a promotional poster for a movie, wherein the poster is dated prior to the point in time that a review of the movie was last updated. The promotional poster may list the lead actors who are starring in the movie. The control circuitry may also retrieve an editor-generated set of data that lists all of the actors who are starring in the movie. The control circuitry may identify the actors listed in the editor-generated set of data that are not listed on the promotional poster. The control circuitry may compare these identified actors to the actors referred to in the review of the movie and determine that any of the actors referred to in the review of the movie that are not listed in the promotional poster are “unimportant” actors.

The control circuitry may determine whether a term of the descriptive asset is important in a number of ways. In one embodiment, the control circuitry may determine whether, at the present time, the term is important by identifying a communication corresponding to the media asset that includes the term, wherein the communication is dated after the point in time. As an illustrative example, the control circuitry may identify a recent editorial review, dated after the descriptive asset was last updated, that includes the term. As another illustrative example, the control circuitry may identify a post on a social network about the media asset that includes the term. Social networks such as Facebook allow a plurality of users to create posts about topics of their choosing, and users may post their own comments about important aspects of media assets. In some embodiments, the control circuitry may determine whether, at the present time, the term is important by determining whether a number of communications relating to the term exceeds a threshold number of communications. Referring back to the social network example above, the control circuitry may determine whether a number of posts on a social network exceeds a threshold number of posts. In some embodiments, the control circuitry may determine whether, at the present time, the term is important by accessing a knowledge graph to determine whether a strength of association between the term and the media asset exceeds a threshold strength. The knowledge graph may be an important source in determining whether an unimportant term has now become an important term with respect to the media asset, by measuring a strength of association between the term and the media asset.

In some embodiments, the control circuitry may generate an updated portion of the descriptive asset relating to the term and update the descriptive asset by incorporating the updated portion into the descriptive asset. For example, the control circuitry may automatically update a sentence that lists the major actors of the media asset with the name of a previously-unimportant actor. The updated portion may be based on information that is dated after the point in time. The control circuitry may update the descriptive asset by either augmenting the descriptive asset (i.e., add the updated portion to the existing descriptive asset) or by replacing a corresponding portion of the descriptive asset with the updated portion.

It should be noted that the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display screen for use in accessing media content in accordance with some embodiments of the disclosure;

FIG. 2 shows another illustrative example of a display screen used access media content in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 shows an illustrative descriptive asset screen in accordance with some embodiments of the disclosure;

FIG. 6 is a flowchart of illustrative steps for determining whether a descriptive asset needs to be updated in accordance with some embodiments of the disclosure; and

FIG. 7 is another flowchart of illustrative steps for determining whether a descriptive asset needs to be updated in accordance with some embodiments of the disclosure.

### DETAILED DESCRIPTION OF THE DRAWINGS

Systems and methods are described herein for determining whether a descriptive asset needs to be updated. As used herein, a “descriptive asset” may refer to any information which describes a media asset, including, but not limited to, a review, synopsis/summary, trailer, preview, or article. Although the systems and methods described herein are described in relation to a text descriptive asset, it will be understood by those of skill in the art that the systems and methods described herein could also be applied to a descriptive asset the comprises images, video, audio, text, or any combination of the above without departing form the scope thereof.

In order to determine whether a descriptive asset needs to be updated, control circuitry may determine whether terms of a descriptive asset are “important” or “unimportant” as of a point in time. As used herein, the terms “important” and “unimportant” are used to denote a relative significance of the term as of the point in time. The relative significance of the term may be determined in a number of ways. In some embodiments, significance may be measured in terms of popularity. For instance, the control circuitry may determine that a number of people rate the term positively or have a positive sentiment toward the term. If the number of people exceeds a threshold value, then the control circuitry may deem the term as significant and “important.” If the number of people who rate the term positively or that have a positive sentiment toward the term does not exceed a threshold value, then the control circuitry may deem the term as insignificant and “unimportant.” In some embodiments, the significance of a term may be measured in terms of public awareness or knowledge of the term. As an illustrative example, the term in the descriptive asset may be an actor's name, and the control circuitry may determine how many people are aware of the actor's existence. If the number of people who are aware of the actor's existence exceeds a threshold value, then the actor's name (i.e., the term from the descriptive asset) may be deemed as significant and “important.”

As used herein, an “editor-generated set of data” may refer to any data that has been authored or created by a human, including, but not limited to, a list of actors starring in the media asset, a director/producer of the media asset, genre/subject/themes of the media asset, and objects that are depicted in the media asset. As used herein, “promotional material” refers to any material that is intended to promote or increase the popularity of a media asset. For example, promotional material may include a movie poster or a movie trailer. In some embodiments, the promotional material may be a truncated set of the editor-generated set (e.g., to highlight marquis features of a media asset). Both the “editor-generated set of data” and “promotional material” may include images, video, audio, text, or any combination thereof.

In some embodiments, control circuitry may access knowledge graphs in order to determine whether terms of a descriptive asset are important or unimportant. Knowledge graphs and their features are described in greater detail in U.S. patent application Ser. No. 14/501,504, filed Sep. 30, 2014, U.S. patent application Ser. No. 14/500,309, filed Sep. 29, 2014, and U.S. patent application Ser. No. 14/448,308, filed Jul. 31, 2014, which are hereby incorporated by reference herein in their entireties. In some embodiments, control circuitry may access the knowledge graph to identify a strength of association between the term of the descriptive asset and the media asset. As used herein, a “strength of association” between a first term and a second term refers to the probability that a first term will be included in a communication if the second term is also included in the communication. As an illustrative example, the terms “Tom Cruise” and “Top Gun” may often appear in communications or descriptive assets because Tom Cruise is an actor in the movie Top Gun. As a result, the strength of association between the terms “Tom Cruise” and “Top Gun” may be relatively high. Strength of association may be indicated in any suitable manner, including numerically or by qualitative categories (e.g., “high,” “medium,” “low”).

According to one aspect, control circuitry may determine that a descriptive asset corresponding to a media asset may require revision. The descriptive asset may have been last updated at a point in time. For instance, the descriptive asset may have been created or edited at some time in the past. In some embodiments, the control circuitry may determine that the descriptive asset may require revision by determining that a set period of time has elapsed since the point in time. In this manner, the control circuitry may periodically check whether the descriptive asset has become outdated.

The control circuitry may determine that a review needs to be updated by identifying any suitable aspect of a descriptive asset that has become outdated. The following illustrative examples depict a few of the potential aspects of a descriptive asset that may be analyzed by control circuitry. The control circuitry may, for example, determine that a movie starred what was then a little known actor, but today, is a star. The control circuitry may retrieve a review of a band that had little relevance when active, but has become an important musical influence decades later. The control circuitry may identify the subject matter of a documentary that was little known at the time of release, but that has become relevant in view of current national or world events. The control circuitry may also identify the subject matter of the documentary as relevant to the current political landscape. These examples have been provided for illustrative purposes only, and it will be apparent to those of skill in the art that other variations and modifications can be made without departing from the scope hereof.

In some embodiments, the control circuitry may determine that the descriptive asset needs to be updated by accessing information on the Internet that relates to the media asset. The following illustrative examples depict a few of the factors that the control circuitry may analyze in order to determine whether the descriptive asset needs to be updated. The control circuitry may identify communications on the Internet that mention the media asset, determine whether these communications exceeds a threshold number of communications, and track the tone of those communications. For instance, the control circuitry may access an online forum in which users may post comments about the media asset. The control circuitry may use software to automatically identify keywords or phrases used in the posts associated with either positive sentiment or negative sentiment of the users. Depending on the tone and/or how many users express a similar tone, the control circuitry may determine that the descriptive asset needs to be updated to reflect this positive/negative tone. The control circuitry may also track the number of times the media asset has been mentioned in news articles, such as political or tech news. The control circuitry may also identify new websites that have been created, such as blogs or fansites, that relate to the media asset. In some embodiments, the control circuitry may track communications on social media networks to determine whether the media asset is rising or falling in popularity. For instance, the social media service Twitter allows users to post “Tweets” that are short communications that are 140 characters or less. Users typically “tag” their tweets as related to a particular subject matter by using a hashtag (typically indicated by the symbol “#”). Control circuitry may be used to automatically determine a topic of a Tweet by detecting a hashtag symbol and identifying a keyword or phrase that follows the hashtag symbol. The control circuitry may track a number of Tweets and determine that the media asset and/or term associated with the media asset is either rising or falling in popularity based on the number Tweets and the speed with which they are created. These examples have been provided for illustrative purposes only, and it will be apparent to those of skill in the art that other variations and modifications can be made without departing from the scope hereof.

In some embodiments, the control circuitry may retrieve the descriptive asset from a database and analyze each term of a plurality of terms of the descriptive asset to identify terms that, at the point in time, were unimportant. In response to identifying a term of the plurality of terms that, at the point in time, was unimportant, the control circuitry may determine whether, at a present time, the term is now important. As an illustrative example, the descriptive asset may be a plot summary of a movie and identify a number of lead actors and a number of secondary actors. The control circuitry may determine that a secondary actor was unimportant at the point in time that the descriptive asset was last updated. For instance, the secondary actor may have been a new actor who was relatively unknown at the time. The control circuitry may then determine that the secondary actor is now important. For instance, the control circuitry may access an Internet database with actor information and determine, based on information in the Internet database, that the secondary actor has played the lead role in several recent blockbuster movies. In response to determining that, at the present time, the term in the descriptive asset is now important, the control circuitry may generate a notification to update the descriptive asset. For example, the control circuitry may generate an alert to a human editor of the descriptive asset that the descriptive asset needs to be updated.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

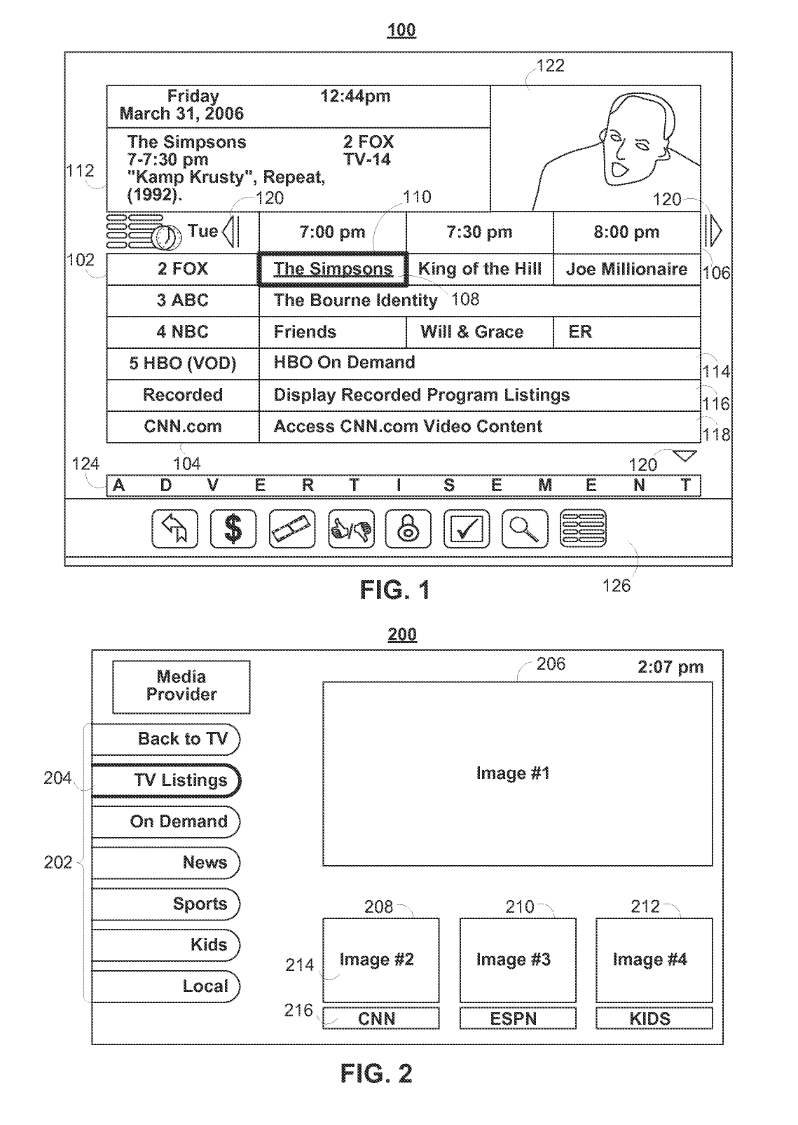

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

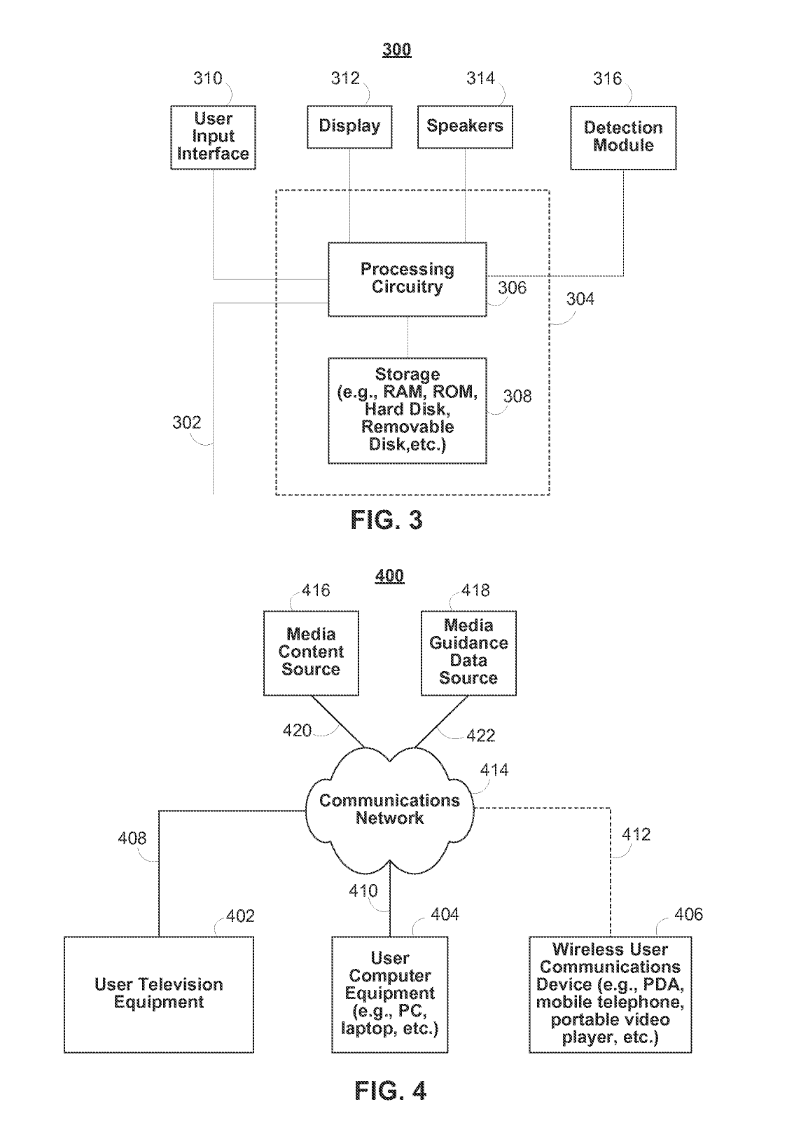

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

In some embodiments, the media guidance data source 418 may comprise a database that stores descriptive assets. The media guidance data source 418 may be provided by the same media provider that manages the media content source 416, or by a different media provider. For example, the media guidance data source 418 may be an Internet database that compiles information about media assets such as editor reviews, user reviews, and/or summaries of the media asset. The media guidance data source 418 may also comprise a social media network server that maintains communications for an online social media network. For instance, media guidance data source 418 may be a Facebook server that receives, stores, and transmits posts from a plurality of Facebook users. In some embodiments, the media guidance data source 418 may also store promotional material, including, but not limited to, images (e.g., posters), video, audio, or text intended to promote and/or increase the popularity of a media asset. The media guidance data source 418 may also store editor-generated data, such as list of actors starring in the media asset, director/producer of the media asset, genre/subject/themes of the media asset, objects that are depicted in the media asset, or any other information related to the media asset. Control circuitry, such as control circuitry 304, may query the media guidance data source 418 to provide any of the above information for determining whether a descriptive asset needs to be updated. In some embodiments, the media guidance data source 418 may even provide indications of whether certain terms are “important” to the media asset. For instance, the media guidance data source 418 may comprise a database that stores keywords and phrases that are associated with the media asset. The database may include a knowledge graph that maps connections between the media asset and various keywords and phrases and stores a strength of association between the keyword/phrases and the media asset. In some embodiments, the control circuitry 304 may access the knowledge graph and use the strength of association to determine whether a term in a descriptive asset is important as of a point in time.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

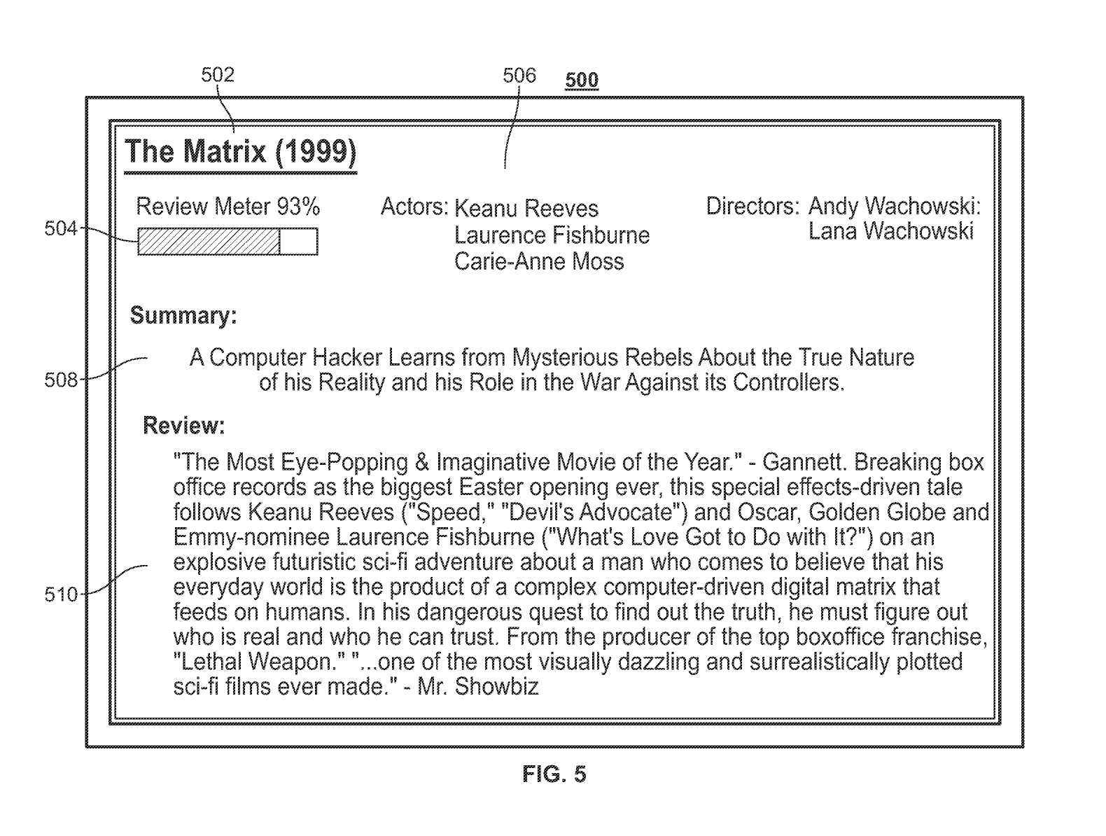

FIG. 5 shows an illustrative descriptive asset screen 500 in accordance with some embodiments of the disclosure. The descriptive asset screen 500 includes a title 502, a review meter 504, a media asset information section 506, a first descriptive asset 508, and a second descriptive asset 510. It will be understood by those of skill in the art that the descriptive asset screen 500 is shown for illustrative purposes only, and that elements may be added or removed and/or rearranged without departing from the scope thereof. For instance, although two descriptive assets (a summary and a review) are shown in descriptive asset screen 500, it will be understood that the descriptive asset screen 500 may include only one descriptive asset.

The descriptive asset screen 500 may be implemented on any suitable user equipment, such as any one of the user equipment 402, 404, or 406 depicted in FIG. 4. The descriptive asset screen 500 may be displayed on any suitable display, such as display 312 depicted in FIG. 3, and audio components of the descriptive asset screen 500 (e.g., audio accompanying for any video trailers or previews) may be produced by any suitable audio device, such as speakers 314 depicted in FIG. 3. The descriptive asset screen 500 may be produced in response to a user input through user input interface 310, such as through a keyboard, mouse, or remote control. For example, the descriptive asset screen 500 may be produced in response to a user selection of a media asset in a media guidance screen and/or in response to a request for additional information about the media asset (e.g., through a “more information” button on the remote control). The descriptive asset screen 500 may also be produced in response to a user input through detection module 316, which may include both visual sensors to detect physical gestures and audio sensors, such as a microphone, to detect audio/speech inputs.

In some embodiments, control circuitry 304 may provide the descriptive asset screen 500 as part of an interactive media guidance application. The control circuitry 304 may generate for display the title 502 of the media asset and may populate media asset information section 506 with editor-generated data, including, as depicted in FIG. 5, actor/actresses that are portrayed in the media asset and/or director/producer information. The control circuitry 304 may also populate the media asset information section 506 with other information, including, but not limited to, a genre of the media asset, a format of the media asset (e.g., high definition, low definition, etc.), a parental rating of the media asset, news/social media related to the media asset, or any other information relating to the media asset. The control circuitry 304 may retrieve the editor-generated data from a database, such as media guidance data source 418.

In some embodiments, control circuitry 304 may provide a rating of the media asset, such as review meter 504. Although the review meter 504 is depicted as a bar indicator, any suitable method of displaying a review or rating may be utilized without departing from the scope thereof. In some embodiments, control circuitry 304 may retrieve the rating of the media asset from local memory, such as storage 308. In some embodiments, control circuitry 304 may query a database, such as media guidance data source 418, for ratings or review information and generate for display such information as review meter 504.

In some embodiments, control circuitry 304 may generate for display a first descriptive asset 508 and a second descriptive asset 510. The control circuitry 304 may retrieve the first descriptive asset 508 and the second descriptive asset 510 either from local memory, such as storage 308, or from a database, such as media guidance data source 418. In some embodiments, the control circuitry 304 may retrieve the first descriptive asset 508 from a different data source than the second descriptive asset 510, while in other embodiments, the control circuitry 304 may retrieve the first descriptive asset 508 from the same data source as the second descriptive asset 510. The control circuitry 304 may also identify a creation time and/or a last update time for each of the descriptive assets 508 and 510.

The control circuitry 304 may analyze the descriptive assets 508 and 510 to identify terms (i.e., keywords or phrases) that are either important or unimportant. In one embodiment, the control circuitry 304 may access a database, such as media guidance data source 418, that lists terms related to the media asset, and may compare the terms in the database to the terms in the descriptive assets 508 and/or 510. In some embodiments, the database may include a knowledge graph that maintains a list of terms that are related to the media asset as well as a strength of association of a link between each of the terms and the media asset. The control circuitry 304 may identify terms of the descriptive assets 508 and 510 that are unimportant by comparing the terms of the descriptive assets 508 and 510 with editor-generated data, such as the data depicted in media asset information section 506. The control circuitry 304 may identify any terms from the descriptive assets 508 and 510 that are not listed in the editor-generated data as unimportant. In some embodiments, the control circuitry 304 may access a knowledge graph and determine that terms from the descriptive assets 508 and 510 that do not meet a threshold strength of association are unimportant.

In some embodiments, the control circuitry 304 may compare terms from promotional material with terms from the editor-generated data depicted in the media asset information section 506. For instance, the control circuitry 304 may access a promotional poster that lists the lead actors in the movie. The control circuitry 304 may compare this list of lead actors with the editor-generated data and identify a subset of terms from the editor-generated data that are not included in the promotional poster. The control circuitry 304 may then compare the terms from descriptive assets 508 and/or 510 with the identified subset of terms from the editor-generated data. The control circuitry 304 may determine that any terms from the descriptive assets 508 and/or 510 that match one of the identified subset of terms from the editor-generated data are unimportant.

In some embodiments, the control circuitry 304 may identify one or more communications about a media asset that include a term from the descriptive assets 508 and 510. For example, the control circuitry 304 may access media guidance data source 418 to retrieve communications or indications or communications that relate to the media asset. In some embodiments, the communications may be associated with metadata that identifies them as related to the media asset. In some embodiments, the control circuitry 304 may determine that the number of communications about the media asset exceeds a threshold number of communications, and based on the determination, generate an indication that the descriptive asset needs to be updated. In some embodiments, the control circuitry 304 may also determine that a number of communications that include a term from the descriptive asset exceeds a threshold number of communications, and based on the determination, generate an indication that the term of the descriptive asset needs to be updated.

In some embodiments, the control circuitry 304 may update the first descriptive asset 508 and/or the second descriptive asset 510. For example, the control circuitry 304 may replace the first descriptive asset 508 with a brand new summary based on information dated after the first descriptive asset 508 was last updated. As another example, the control circuitry 304 may generate an extra sentence for the second descriptive asset 510 and augment the second descriptive asset 510 with the extra sentence. The extra sentence may be generated, for example, from a critic review of the media asset that was created after the second descriptive asset 510 was last updated. In some embodiments, the control circuitry 304 may replace a corresponding sentence in the second descriptive asset 510 with the generated extra sentence.

In some embodiments, the media asset information section 506 may include the names of other media assets or creators of media assets that are an influence or influenced by the media asset. As an illustrative example, the media asset information section 506 may list the movies “Equilibrium” and “Wanted” as movies that were influenced by “The Matrix.” In some embodiments, a human editor may determine whether a first media asset and/or a creator of the first media asset influences a second media asset and/or a creator of the second media asset. For example, a well-known critic of jazz music may determine that trumpet player “Louis Armstrong” was influential to trumpet player “Dizzy Gillespie.” In response to determining that a media asset, or a creator of the media asset, is influential or is influenced by another media asset or creator of another media asset, the control circuitry 304 may determine that the descriptive asset for the media asset needs to be updated.

In some embodiments, the media asset information section 506 may include information about the subject or themes of the media asset. As an illustrative example, a medical documentary may focus on a particular research technique, or a science fiction movie may focus on a particular technology that is not available at the time that the movie was created. A human editor may determine whether there has been a change in the subject or themes of the media asset over time. Referring to the above examples, a human editor may determine that the particular research technique of the medical documentary has been debunked, or that the particular technology that was not available at the time that the movie was created is now available in a similar form/usage. As another illustrative example, a media asset made in the 1950s may focus on the racially charged theme of segregation of schools. A human editor may determine that public sentiment surrounding the theme of segregation may have changed over time. In some embodiments, control circuitry may determine that there has been a change in the theme of a media asset. For instance, control circuitry may identify a plurality of communications that relate to the media asset that discuss the theme. The control circuitry may identify a number of the plurality of communications that express a negative or a positive sentiment towards the theme, and if the number of communications exceeds a threshold number of communications, may identify the theme as having a positive or negative sentiment. The control circuitry may determine that there has been a change in the sentiment toward a theme by comparing communications authored around the time that the descriptive asset was last updated and communications authored at a current time. In response to determining that there has been a change in the subject or themes of the media asset, control circuitry may determine that the descriptive asset of the media asset needs to be updated.

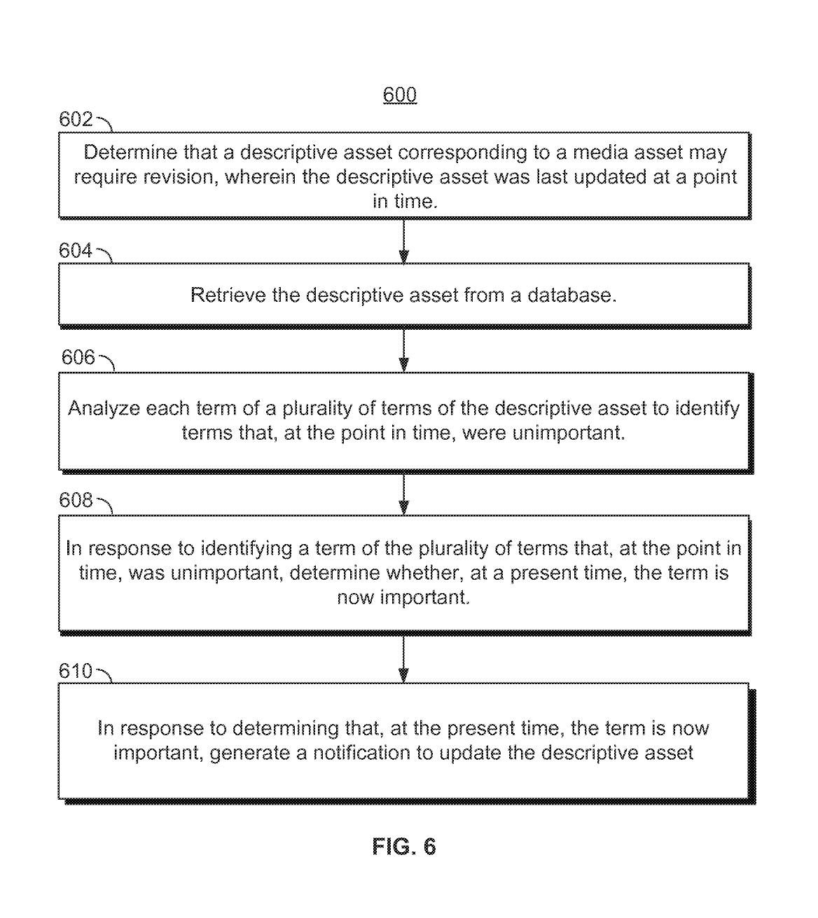

FIG. 6 is a flowchart 600 of illustrative steps for determining whether a descriptive asset needs to be updated in accordance with some embodiments of the disclosure. Flowchart 600 includes determining that a descriptive asset corresponding to a media asset may require revision, wherein the descriptive asset was last updated at a point in time at 602, retrieving the descriptive asset from a database at 604, analyzing each term of a plurality of terms of the descriptive asset to identify terms that, at the point in time, were unimportant at 606, in response to identifying a term of the plurality of terms that, at the point in time, was unimportant, determining whether, at a present time, the term is now important at 608, and in response to determining that, at the present time, the term is now important, generating a notification to update the descriptive asset at 610. It should be noted that process 600 could be performed on, or provided by, any of the devices or combination of devices shown in FIGS. 3 and 4. For example, process 600 may be executed by control circuitry 304 (FIG. 3) or by control circuitry implemented on user equipment 402, 404, and/or 406 (FIG. 4). In addition, one or more steps of process 600 may be incorporated into or combined with one or more steps of any other process or embodiments.

At 602, the control circuitry 304 may determine that a descriptive asset corresponding to a media asset may require revision, wherein the descriptive asset was last updated at a point in time. The control circuitry 304 may determine that the descriptive asset may require revision using any suitable method. For example, the control circuitry 304 may determine whether a period of time has elapsed since the descriptive asset was created or last updated. In some embodiments, the control circuitry 304 may determine whether the media asset has exceeded or fallen below a certain popularity threshold, and in response to determining that the media asset has exceeded or fallen below the popularity threshold, determine that the descriptive asset needs to be updated. For instance, the control circuitry 304 may receive communications or indications of communications from a data source, such as media guidance data source 418 (FIG. 4) that relate to the media asset through communication network 414. The control circuitry 304 may determine that the number of communications relating to the media asset exceeds a threshold number of communications, and in response, determine that the descriptive asset needs revision.

At 604, the control circuitry 304 may retrieve the descriptive asset from a database. For example, the control circuitry 304 may retrieve the descriptive asset from local storage 308 (FIG. 3) or from media guidance data source 418 through communication network 414. At 606, the control circuitry 304 may analyze each term of a plurality of terms of the descriptive asset to identify terms that, at the point in time, were unimportant. The control circuitry 304 may identify each of the terms of the descriptive asset using any suitable manner. For example, the control circuitry 304 may parse the descriptive asset into keywords and phrases and compare these keywords and phrases to a list of terms related to the descriptive asset. The list of terms related to the descriptive asset may be created by an editor, and may be stored either in local storage 308 (FIG. 3) or in media guidance data source 418.

The control circuitry 304 may determine that terms in the descriptive asset are unimportant using any suitable method. In some embodiments, the control circuitry 304 may access a database of terms related to the descriptive asset that indicates that the term is unimportant. In such embodiments, a human editor may have manually input, at the time that the descriptive asset was last updated, an indication of whether or not a term of the descriptive asset is important. As an illustrative example, the descriptive asset may list the lead actors and the secondary actors that star in the media asset. The control circuitry 304 may identify the lead actors as important terms and the secondary actors as unimportant terms in the descriptive asset. The control circuitry 304 may also access a knowledge graph which maintains links and strength of associations between terms and the media asset. The control circuitry 304 may identify any terms of the descriptive asset that fall below a threshold strength of association with the media asset. As an illustrative example, control circuitry 304 may set a threshold strength of association of “10” as indicating an “important” keyword. The term “sci-fi” may have a strength of association of “15” with the movie “The Matrix,” exceeding the threshold, and will thus be deemed an important keyword. In contrast, the term “romance” may have a strength of association of “2” with the movie “The Matrix,” which does not exceed the threshold, and thus be deemed as an unimportant keyword.

At 608, the control circuitry 304 may, in response to identifying a term of the plurality of terms that, at the point in time, was unimportant, determine whether, at a present time, the term is now important. In some embodiments, the control circuitry 304 may access a database, such as media guidance data source 418, to identify a communication corresponding to the media asset that includes the term, wherein the communication is dated after the point in time when the descriptive asset was last updated. For example, the control circuitry 304 may identify a news article about the move “The Matrix” that includes the word “romance.” In response to identifying the news article, the control circuitry 304 may deem the previously unimportant term “romance” as now an important term. In some embodiments, the control circuitry 304 may identify a number of communications about the media asset that include the term, and identify the term as important only if the number of communications exceeds a threshold number of communications. As an illustrative example, the control circuitry 304 may indicate the keyword “romance” as an important keyword to the movie “The Matrix” if more than 500 news articles about “The Matrix” also include the word “romance.”

In some embodiments, the control circuitry 304 may access a database, such as media guidance data source 418, that lists important terms to the media asset. For example, the control circuitry 304 may access an Internet database or a search engine, e.g., through communication network 414, that compiles keywords and phrases that are related to the media asset. The control circuitry 304 may compare the terms that were identified as unimportant, as of the point in time that the descriptive asset was last updated, with the list of important terms retrieved from the database. In some embodiments, the control circuitry 304 may access a knowledge graph that maintains links and a strength of association between terms and the media asset. The control circuitry 304 may determine that a term with a strength of association that exceeds a threshold strength is an important term.

At 610, the control circuitry 304 may, in response to determining that, at the present time, the term is now important, generate a notification to update the descriptive asset. The notification may be generated for display, e.g., on display 312. The notification may be generated for a human editor, indicating to the editor that the descriptive asset needs to be updated. The notification may also be generated for an end user, for example on user equipment 402, 404, or 406. The notification may indicate to the end user that the descriptive asset may be outdated and requires an update.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-5 could be used to perform one or more of the steps in FIG. 6.

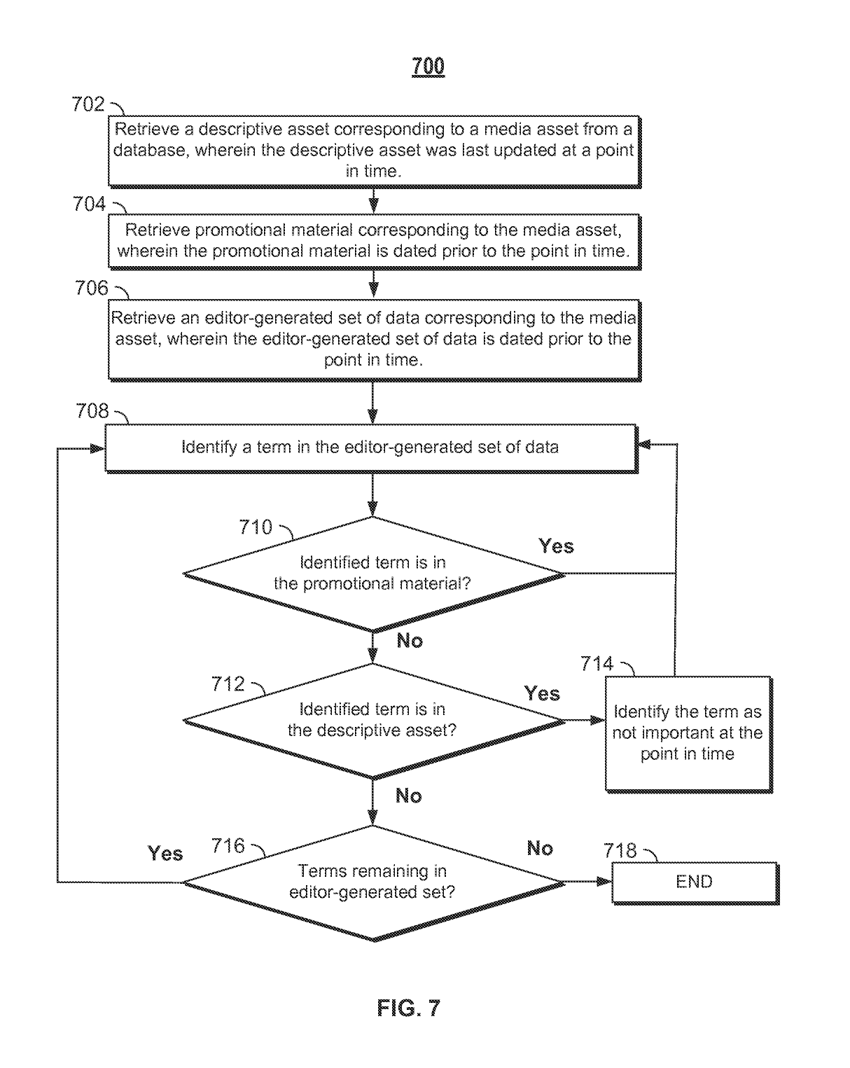

FIG. 7 is a flowchart 700 of illustrative steps for determining whether a descriptive asset needs to be updated in accordance with some embodiments of the disclosure. Flowchart 700 includes retrieving a descriptive asset corresponding to a media asset from a database, wherein the descriptive asset was last updated at a point in time at 702, retrieving promotional material corresponding to the media asset, wherein the promotional material is dated prior to the point in time at 704, retrieving an editor-generated set of data corresponding to the media asset, wherein the editor-generated set of data is dated prior to the point in time at 706, identifying a term in the editor-generated set of data at 708, determining whether the identified term is in the promotional material at 710, determining whether the identified term is in the descriptive asset at 712, identifying the term as not important at the point in time at 714, determining whether any unidentified terms remain in the editor-generated set of data at 716, and ending at 718. It should be noted that process 700 could be performed on, or provided by, any of the devices or combination of devices shown in FIGS. 3 and 4. For example, process 700 may be executed by control circuitry 304 (FIG. 3) or by control circuitry implemented on user equipment 402, 404, and/or 406 (FIG. 4). In addition, one or more steps of process 700 may be incorporated into or combined with one or more steps of any other process or embodiments.

At 702, the control circuitry 304 may retrieve a descriptive asset corresponding to a media asset from a database, wherein the descriptive asset was last updated at a point in time. 702 may be substantially similar to 604 depicted in FIG. 6. At 704, the control circuitry 304 may retrieve a promotional material corresponding to the media asset, wherein the promotional material is dated prior to the point in time. The control circuitry 304 may retrieve the promotional material at the same data source (e.g., media guidance data source 418) or at a different data source as the descriptive asset. The promotional material may comprise text, images, audio, video, or any combination thereof that is intended to promote or increase the popularity of the media asset. The promotional material may be associated with a time of creation or a time that the promotional material was last updated.

At 706, the control circuitry 304 may retrieve an editor-generated set of data corresponding to the media asset, wherein the editor-generated set of data is dated prior to the point in time. The control circuitry 304 may retrieve the editor-generated set of data at the same data source (e.g., media guidance data source 418) or at a different data source as the descriptive asset and the promotional material. That is, the descriptive asset, the promotional material, and the editor-generated set of data may be received from the same data source or from different data sources. The editor-generated set of data may comprise any data related to the media asset that was created by a human editor and may comprise text, images, audio, video, or any combination thereof. The editor-generated set of data may be associated with a time of creation or a time that the promotional material was last updated.

At 708, the control circuitry 304 may identify a term in the editor-generated set of data. The control circuitry 304 may identify the term in any suitable manner, including keyword searches and text/speech recognition software. In some embodiments, the control circuitry 304 may compare each term of the editor-generated set of data with a list of known keywords/phrases associated with the media asset. The list of known keywords/phrases may be stored either in local storage 308 or at media guidance data source 418. At 710, the control circuitry 304 may determine whether the identified term is in the promotional material. The control circuitry 304 may determine whether the identified term is in the promotional material by performing a keyword search for the term in the promotional material. If the identified term is in the promotional material, the term may be marked as an important term, and the control circuitry may return to step 708 to identify another term in the editor-generated set of data. As an illustrative example, the promotional material may be a “sneak peek” article posted in a movie magazine. The article may include the names of the lead actors to be depicted in the movie magazine. The editor-generated data may include every actor that starred in the movie, and any actors that were mentioned in the sneak peek article may be identified as important.

If the identified term is not in the promotional material, the control circuitry 304 may determine whether the identified term is in the descriptive asset at 712. The control circuitry 304 may determine whether the identified term is in the descriptive asset using any suitable means, including performing a keyword search for the term in the descriptive asset or using text/speech recognition software on the descriptive asset to search for the term. If the identified term is in the descriptive asset, the control circuitry 304 may identify the term as not important at the point in time that the descriptive asset was last updated at 714. The control circuitry 304 may then return to 708 to identify another term in the editor-generated set of data.

If the identified term is not in the descriptive asset, then the control circuitry 304 may continue to 716 and determine whether there are any unidentified terms in the editor-generated set of data. If there are unidentified terms, then the control circuitry may return to 708 to identify a remaining term in the editor-generated set of data. If there are no more unidentified terms remaining in the editor-generated set of data, then the control circuitry 304 may terminate at 718.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-5 could be used to perform one or more of the steps in FIG. 7.

It will be apparent to those of ordinary skill in the art that methods involved in the present invention may be embodied in a computer program product that includes a computer-usable and/or readable medium. For example, such a computer-usable medium may consist of a read-only memory device, such as a CD-ROM disk or conventional ROM devices, or a random access memory, such as a hard drive device or a computer diskette, having a computer-readable program code stored thereon. It should also be understood that methods, techniques, and processes involved in the present invention may be executed using processing circuitry. For instance, determining whether a descriptive asset needs to be updated may be performed by processing circuitry, e.g., by processing circuitry 306 of FIG. 3. The processing circuitry, for instance, may be a general purpose processor, a customized integrated circuit (e.g., an ASIC), or a field-programmable gate array (FPGA) within user equipment 300, media content source 416, or media guidance data source 418. For example, the descriptive asset as described herein may be stored in, and retrieved from, storage 308 of FIG. 3, or media guidance data source 418 of FIG. 4. Furthermore, processing circuitry, or a computer program, may determine whether unimportant terms in the descriptive asset have become important as of a present time.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for determining whether a descriptive asset needs to be updated, the method comprising:
determining that a descriptive asset corresponding to a media asset may require revision, wherein the descriptive asset was last updated at a point in time;
retrieving the descriptive asset from a database;
analyzing each term of a plurality of terms of the descriptive asset to identify terms that, at the point in time, were unimportant;
in response to identifying a term of the plurality of terms that, at the point in time, was unimportant, determining whether, at a present time, the term is now important; and
in response to determining that, at the present time, the term is now important, generating a notification to update the descriptive asset.

2. The method of claim 1, wherein analyzing each term of the plurality of terms of the descriptive asset to identify the terms that, at the point in time, were unimportant, comprises:
retrieving promotional material corresponding to the media asset, wherein the promotional material is dated prior to the point in time;
retrieving an editor-generated set of data corresponding to the media asset, wherein the editor-generated set of data is dated prior to the point in time;
identifying a subset of terms of the editor-generated set comprising terms that are not in the promotional data;
comparing each term of the plurality of terms of the descriptive asset to the subset of terms; and
determining that each term of the plurality of terms that matches a term of the subset was not important at the point in time.

3. The method of claim 1, wherein determining whether, at the present time, the term is important comprises identifying a communication corresponding to the media asset that includes the term, and wherein the communication is dated after the point in time.

4. The method of claim 1, wherein determining whether, at the present time, the term is important comprises determining whether a number of communications relating to the term exceeds a threshold number of communications.

5. The method of claim 1, wherein determining whether, at the present time, the term is important comprises accessing a knowledge graph to determine whether a strength of association between the term and the media asset exceeds a threshold strength.

6. The method of claim 1, wherein determining that the descriptive asset corresponding to the media asset may require revision comprises determining whether a period of time has passed after the point in time.

7. The method of claim 1, further comprising:
generating an updated portion of the descriptive asset relating to the term; and
updating the descriptive asset by incorporating the updated portion into the descriptive asset.

8. The method of claim 7, wherein the updated portion is generated based on information that is dated after the point in time.

9. The method of claim 7, wherein updating the descriptive asset comprises replacing a corresponding portion of the descriptive asset with the updated portion.

10. The method of claim 1, wherein the descriptive asset is one of a review, synopsis/summary, trailer, preview, or an article.

11. A system for determining whether a descriptive asset needs to be updated, the system comprising:
control circuitry configured to:
determine that a descriptive asset corresponding to a media asset may require revision, wherein the descriptive asset was last updated at a point in time;
retrieve the descriptive asset from a database;
analyze each term of a plurality of terms of the descriptive asset to identify terms that, at the point in time, were unimportant;
in response to identifying a term of the plurality of terms that, at the point in time, was unimportant, determine whether, at a present time, the term is now important; and
in response to determining that, at the present time, the term is now important, generate a notification to update the descriptive asset.

12. The system of claim 11, wherein the control circuitry is configured to analyze each term of the plurality of terms of the descriptive asset to identify the terms that, at the point in time, were unimportant, by:
retrieving promotional material corresponding to the media asset, wherein the promotional material is dated prior to the point in time;
retrieving an editor-generated set of data corresponding to the media asset, wherein the editor-generated set of data is dated prior to the point in time;
identifying a subset of terms of the editor-generated set comprising terms that are not in the promotional data;
comparing each term of the plurality of terms of the descriptive asset to the subset of terms; and
determining that each term of the plurality of terms that matches a term of the subset was not important at the point in time.

13. The system of claim 11, wherein the control circuitry is configured to determine whether, at the present time, the term is important by identifying a communication corresponding to the media asset that includes the term, and wherein the communication is dated after the point in time.

14. The system of claim 11, wherein the control circuitry is configured to determine whether, at the present time, the term is important by determining whether a number of communications relating to the term exceeds a threshold number of communications.

15. The system of claim 11, wherein the control circuitry is configured to determine whether, at the present time, the term is important by accessing a knowledge graph to determine whether a strength of association between the term and the media asset exceeds a threshold strength.

16. The system of claim 11, wherein the control circuitry is configured to determine that the descriptive asset corresponding to the media asset may require revision by determining whether a period of time has passed after the point in time.

17. The system of claim 11, wherein the control circuitry is further configured to:
generate an updated portion of the descriptive asset relating to the term; and
update the descriptive asset by incorporating the updated portion into the descriptive asset.

18. The system of claim 17, wherein the updated portion is generated based on information that is dated after the point in time.

19. The system of claim 17, wherein the control circuitry is configured to update the descriptive asset by replacing a corresponding portion of the descriptive asset with the updated portion.

20. The system of claim 11, wherein the descriptive asset is one of a review, synopsis/summary, trailer, preview, or an article.

21-50. (canceled)
